(19) United States
(12) Patent Application Publication
(10) Pub. No.: US 2005/0133302 A1
(43) Pub. Date: Jun. 23, 2005

(54) Sound shielding element, use thereof and method of producing the same

(76) Inventors: Klaus Pfaffelhuber, Gunzburg (DE); Gunter Kraus, Ehekirchen (DE); Dimitrios Patsouras, Dachau (DE)

Correspondence Address: CANTOR COLBURN, LLP, 55 GRIFFIN ROAD SOUTH, BLOOMFIELD, CT, 06002, US

(21) Appl. No.: 10/814,687

(22) Filed: Mar. 30, 2004

Related U.S. Application Data
(63) Continuation of application No. 09/868,860, filed on Jun. 21, 2001, now Pat. No. 6,680,040.

(30) Foreign Application Priority Data
May 6, 1999 (DE) 199 20 969.3
Jul. 9, 1999 (DE) 199 32 175.2
Sep. 2, 1999 (DE) 299 15 428.9
Sep. 2, 1999 (DE) 299 15 429.7

(51) Int. Cl. G09F 3/00; F01N 1/00

(52) U.S. Cl. 181/293; 181/204

(57) ABSTRACT

Sound-shielding element for covering at least one of sound-reflecting or sound-generating structural parts and method for forming the same, the element including at least one panel or layer, a plurality of small perforations formed in the at least one panel or layer, where an average diameter or width of the perforations ranges between 0.001 and 0.7 mm and a hole/surface ratio ranges between 0.001 and 8% so that the sound waves entering the perforations initiate physical effects in a gas volume contained in said perforations.

### CROSS REFERENCE TO RELATED APPLICATION

This application is a continuation of, and claims the benefit of, pending U.S. patent application Ser. No. 09/868,860 filed on 20 Aug. 2001, the entire contents of which are herein incorporated by reference in their entirety.

### FIELD OF INVENTION

The present invention relates to a sound shielding element for protection from the propagation of sound from the noise area of a room or space into a neighbouring room or space or for covering sound-reflecting or sound-generating structural parts, comprising at least one panel or layer containing many small perforations, as well as to a method of producing same and to applications thereof.

### DESCRIPTION OF THE RELATED ART

Such a shielding element is known already (U.S. Pat. No. 5,196,253, European Patent EP-A-0 341 652, German Utility Model U-93 01 234 and German Patent DE-A-1 180 155, all of which patents are herein incorporated by reference in their entirety.) The strong noise generated by the automotive engine or by tyres, air flows and other units causing noise is attenuated by such so-called “sound absorbers” when it enters into the passenger compartment when it is emitted into the environment. Other known sound absorbers present chamber-like interior spaces so that the entering sound waves are largely attenuated by resonance effects. Apart from these chamber-type absorbers also such sound absorbers are known which consist of porous materials such as foams or nonwoven fabrics. Moreover, so-called film and membrane absorbers are known wherein a thin layer formed as film or sheet is caused by the sound waves to vibrate so that, as a result, an energy loss occurs in the sound wave and the sound wave is attenuated.

It is furthermore known (German Patent 43 15 759-C, which is herein incorporated by reference in its entirety) to dispose a transparent glass or plastic panel having a thickness between 2 and 30 mm at a spacing in front of a sound-reflecting wall or ceiling of a large assembly hall, which panel is provided with circular holes having a diameter of 0.2 to 2 mm and a spacing of 2 to 20 mm between the holes. Such glass attachment shells are not easily useful for smaller spaces and particularly in motor vehicles.

### SUMMARY OF THE INVENTION

The present invention is based on the problem of improving a shielding element of the general type mentioned by way of introduction in a way that, being simple to produce, it requires only little space and is suitable for being mounted at many locations e.g. in a motor vehicle or replaces common automotive mounting parts, respectively, or can be mounted thereon without a major loss of space. The shielding element should, however, be applicable not only as mounting part in motor vehicles but also for other purposes.

The invention is characterised in the claims 1 and 2. Accordingly, the sound shielding element comprises at least one panel or layer having a thickness of layer between 0.01 and 50 mm, particularly between 0.05 and 4 mm. Its perforations present an average diameter or an average width between 0.001 and 2 mm, particularly 0.01 and 0.7 mm, and a hole or perforation surface share, related to the total surface of the mounting parts—also referred to as hole/surface ratio”—between 0.001 and 20%, particularly between 0.01 and 5%, including the range 0.1-3%, for instance.

It is known per se, too, to cover seats in motor vehicles, for instance, with a perforated synthetic material or leather in order to permit an exchange of air between the seat so covered and the passenger compartment. In such a case the hole/surface ratio is, as a rule, much higher than in the case of the present invention.

Moreover, it is not decisive in the present invention to provide the sound-reflecting vehicle windows or the windscreen with such a perforated glass attachment panel as this is the case in prior art according to document DE-B-43 15 759; this would not only require substantial space but would be entirely impractical, for instance in the case of movable windows and not useful in the case of windscreens on account of the optical reflections occurring mainly when light is incident at an oblique angle.

In accordance with one variant of the invention, the respective mounting part of the motor vehicle, for instance, is configured as such as “sound absorber” without the necessity to dispose an additional perforated panel at a major spacing in the range of 109 cm in front of this mounting part.

According to one variant of the invention, however, it is also possible to dispose several, particularly more than two, perforated panels at a mutual spacing in a tandem arrangement, which improves the wide-band characteristic in absorption.

The invention has been found to be simple to produce and to mount because the defined perforation of common automotive mounting parts in accordance with the invention does, as a rule, not give rise to any major manufacturing problems. It was a surprise to find that a comparatively wide bandwidth can be achieved in sound absorption by means of the invention, which can be even further improved when the perforated panel then serving as carrier is coated with a porous absorber layer.

Another essential advantage of the invention consists in the aspect that such a material may be used for the perforated panel or layer, that can be easily disposed of in an environmentally acceptable manner together with other automotive mounting parts. Numerous materials may be used in order to satisfy specific demands on loads produced by media and heat, impact loads and optimum appearance.

Finally, such a perforated panel has been found to be also water-repellent and simultaneously permeable to vapour like similar micro-porous textile materials when the holes are appropriately dimensioned.

Particularly preferred materials of the perforated panel or layer are:

Injection-moulded materials such as polypropylene and polyamide, films such as polypropylene and ABS, sheets and strips of aluminium or an aluminium alloy having a preferred thickness of layer of 0.5 mm, and also fibre materials consisting of natural and synthetic fibres and processed to form structured nonwoven and woven fabrics, such as cotton, flax, hemp, coconut fibre or polyester, polypropylene, etc. The inherent rigidity and dimensional stability of these nonwoven materials may, of course, also be improved by a binder matrix of resins or thermoplastic materials, for instance, In the event that a porous covering layer is applied on the perforated panel or layer, respectively, the use of foamed synthetic materials, specifically polyurethane and/or nonwoven fabric consisting of cotton fibres, in particular, is recommendable.

The present invention is applicable for a variety of mounting parts, specifically in motor vehicles, e.g. for roof trimmings, i.e. as inside roof linings, as hat rack or door lining, as sun protector or rear trunk blind, as injection-moulded cover units for covering or sheathing cables or exhaust pipes, on the underbody lining or engine bonnet lining, as thermal shield, particularly in front of aluminium sheets, as well as wheel case shell, particularly in motor cars.

The invention is applicable with particular advantages in large-capacity vehicles such as busses and aircraft where an optimum use of the space is decisive and where, on the other hand, the engine noise in the passenger compartment should be absorbed to the highest degree possible.

In such cases it is possible to render the parts lining the outside wall acoustically effective by means of micro perforation, without the necessity to insert additional absorbing materials between the lining and the outer edge.

It has moreover been found that the manufacture of a layer or panel provided with narrow slots in particular, that is distorted without cutting or three-dimensionally shaped in the region of the slots in any case helps to facilitate the manufacture and moreover improves the acoustic efficiency in terms of sound attenuation and sound insulation. In such a case the slot width, particularly at the widest locations of the slots, should be only within the range from 0.02 to 0.18 mm while the slot length should range between 0.02 and 30 mm.

The manufacture is expediently carried out by providing the layer or panel, respectively, first with the perforations formed as fine slots or holes, to which end cutter blocks or blade carrying rails may be used. In or subsequent to this operation the layer or panel is so drawn and stretched in one or even several directions that it is distorted without cutting in three dimensions in the manner of an expanded metal and forms an irregular surface, in any case in the region about the slots.

The non-cutting distortion may also be achieved by processing the perforated or slotted layer or panel, respectively, with shaping rollers again, to perform the three-dimensional shaping. In this operation slots or holes may be partly closed again by pressing so that the aforementioned slight slot width between 0.02 and 0.18 mm only is achieved in the finished product.

It is recommendable to use aluminium for the layer or the panel, respectively, having a preferred thickness of layer d=0.5 mm.

The perforations are preferably disposed in the layer or panel, respectively, in a high density so that a sieve-like character of the panel or plate is achieved.

In correspondence with another preferred embodiment of the invention the layer including a high number of perforations is configured as self-supporting moulded sound shielding part so that additional layers are not required to form a laminated multi-layer element. The term “moulded part” encompasses here three-dimensionally moulded or shaped panels, thick and thin layers, layers formed as sheets or films, as far as they retain the shaped form in a self-supporting manner when an additional shaping work is not performed for continued moulding. It is preferred, however, that the moulded part is produced from synthetic resin moulding substances, particularly by injection moulding and injection pressing, even though it may also be produced by bending, deep-drawing and similar operations for moulding semi-finished products, for instance. The perforations are so dimensioned that a hole/surface ratio between 0.001 and 20% is achieved for them, particularly in the range between 0.01 and 8%. The thickness of the moulded part or the panel, respectively, is dimensioned to range between 0.01 and 50 mm, particularly between 0.05 and 4 mm, whilst the average width or the average diameter of the perforations corresponds to 0.001 to 2 mm, particularly 0.01 to 0.7 mm.

It was a surprise to find that such an inventive moulded part does not require any superposition of further layers but is integrated as such into or with the carrier, respectively, and yet performs the sound insulation function in an appropriate manner. For suspended facing ceilings in buildings perforated metal panels are known per se, which present a thickness of 0.5 mm and a hole diameter of 0.45 mm at a hole/surface ratio of 0.64%.

The moulded part may have a multi-layer structure or consist of a single layer only; in particular, it presents a three-dimensional configuration and is self-supporting so that it retains the desired configuration specifically when it is used to cover the internal combustion engine at least in part.

Compared against the “mini holes” of the aforementioned perforations with the specified hole ratio, the moulded part may preferably include additional larger perforations serving to fasten it on engine parts, vehicle parts or even parts of walls and floors.

The advantage of this embodiment of the invention consists also in the aspect that such moulded parts can also be mounted additionally at those locations where an excessive propagation of sound can be established only subsequently, without the possibility to make substantial modifications on the fundamental structure.

It was a surprise to find that the inventive sound shielding element performs additionally also a good thermal insulation function even though materials with a good thermal conductivity, such as aluminium, are even preferred. The sieve- or screen-like arrangement of the perforations surprisingly contributes to this effect. The sound shielding element then serves as thermal shielding element at the same time. It may have a multi-layer structure or consist of a single layer only. In this case, too, the panel or layer, respectively, may be shaped three-dimensionally, in particular, so that it may be permanently shaped in the desired configuration because it is self-supporting, particularly it may be shaped to enclose at least partly one part of the exhaust system of an internal combustion engine as such. Compared against the “mini holes” of the aforementioned perforations with the given hole ratio, this sound and thermal shielding element may preferably comprise additional major perforations serving for fastening it on engine parts, vehicle parts or even parts of a wall and a floor. Whenever fasteners such as screws should perform an additional heat-eliminating function it is recommended to fasten it on thermally conductive components.

Thermal shielding panels made of aluminium or aluminium alloys and including slot-like perforations, which are shaped or distorted without cutting by stretching in the manner of “expanded metal” are particularly expedient in terms of production and efficiency. Here a thickness of the panels as low as 0.1 to 1 mm is sufficient while hole/surface ratios between 0.2 and 8% are expedient. After distortion such “expanded metals” may be rolled again for smoothing so that sickle-shaped perforations are achieved whose sickle shape is hardly visible to the naked eye.

One advantage of such sound and thermal shielding elements resides also in the fact that these elements can also be mounted additionally at those locations where an excessively high heat production can be established only subsequently, without the possibility to make major modifications on the fundamental structure.

Even textile objects may be configured in accordance with the invention and may be used, for instance, as shields against solar radiation, particularly in the form of binds, or even as coating or covering material. The sounds absorbing or attenuating effect is also expedient in the case of blinds for covering the luggage trunk in motor vehicles. In such a case it is recommendable to impregnate the tissue, that consists of weft and warp yarns in particular, with thermoplastic or duroplastic synthetic material or duroplastic resins. This provision stiffens the textile material that is perforated or provided with “perforations” due to the tissue structure, but the material may also be shaped three-dimensionally.

### BRIEF DESCRIPTION OF THE DRAWINGS

In the following, embodiments of the invention will be described in more details with reference to the drawing wherein:

FIG. 1 is a schematic plan view of a sound and thermal shielding element fastened on the floor of a motor vehicle in the vicinity of the exhaust system for shielding other components of the motor vehicle from the heat and sound generated in the direct region of the exhaust system;

FIG. 2 is a partial view of an automotive mounting part wherein the inventive sound shielding element is produced as moulded part and serves to cover one part of the engine;

FIG. 3a is a schematic plan view of an inventive sound shielding element configured as automotive mounting part, and

FIG. 3b shows a schematic cross-sectional view taken through the three-dimensionally shaped mounting part illustrated in FIG. 3a;

FIG. 4 shows a strongly enlarged partial section from an inventive sound shielding element in the area of a circular perforation;

FIG. 5 is a plan view onto the region of the sounds shielding element configured as automotive mounting part, around a hole having a circular cross-section;

FIG. 6 shows a strongly enlarged schematic partial section from an inventive sounds and thermal shielding panel, and

FIG. 7 illustrates another embodiment of the invention in the sense of “expanded metal”;

FIGS. 8 and 10 illustrate partial plan views of shielding elements according to the invention at an enlarged scale;

FIGS. 9 and 11 illustrate corresponding, even further enlarged phantom views through the shielding elements of FIGS. 8 and 10; and

FIGS. 12 and 15 show examples of the arrangement of inventive sound shielding elements.

### DETAILED DESCRIPTION OF THE PREFERRED EMBODIMENT

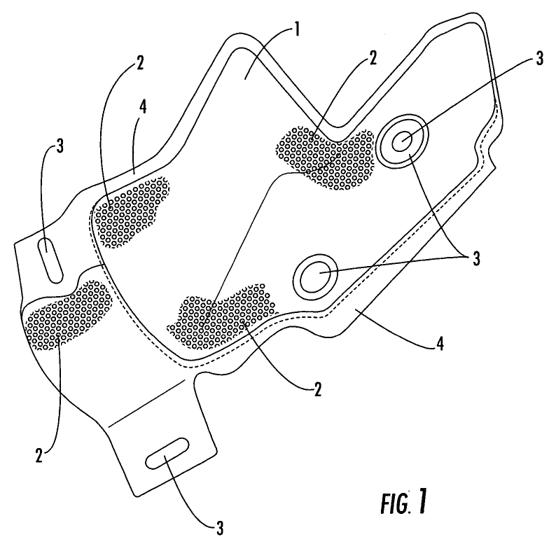

The sound and thermal shielding panel 1 according to FIG. 1, having a thickness of layer d=0.5 mm, is provided with small perforations 2 in correspondence with the inventively selected dimensioning in a screen-like arrangement over almost the entire area (The Figure shows only parts of the perforation zones even when the entire panel 1 is correspondingly “perforated”. The larger perforations 3 in the form of elongate holes or circular holes serve to fasten the element on the floor of the motor vehicles by inserting screws through the perforations 3 and screw-fastening the panel 1 made of aluminium there directly on metal parts, too. The panel 1 presents a three-dimensional shaping in correspondence with the floor formations and the exhaust system with the exhaust tube, and presents a peripheral edge 4 on the outside. Despite its small panel thickness the entire panel 1 is dimensionally stable in the sense that it retains its shape unless it is forcibly deformed by application of forces.

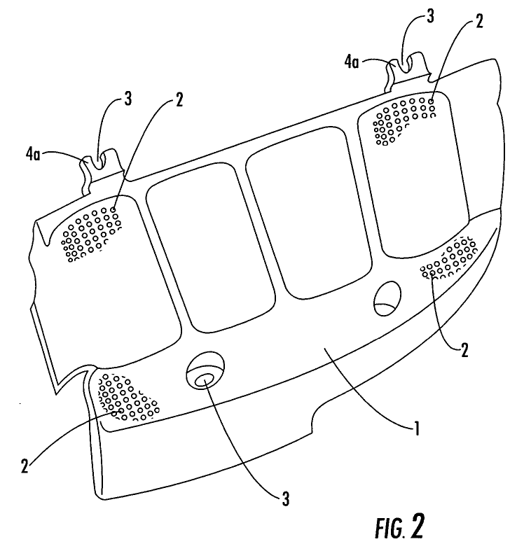

The sound shielding element according to FIG. 2, that serves to cover the engine, is configured as one-piece polypropylene injection moulded part having a layer thickness of d=0.5 mm. In accordance with the invention, it is equally provided over almost the entire surface with small perforations 2 disposed in a screen-like manner. The larger perforations 3 or recesses serve for fastening on the chassis of the motor vehicle here, too, by passing screws through the perforations 3 and screw-fastening the moulded part. The moulded part hence constitutes some kind of a three-dimensionally shaped panel 1, is shaped in correspondence with the formations of the engine housing, and presents connecting flanges 4a on the outside. Despite its low panel thickness the entire moulded part is dimensionally stable in the sense that it retains its shape. The perforations 2 also perform an “antidrum” function because they change the vibration characteristics of the moulded part substantially, despite the small dimensions.

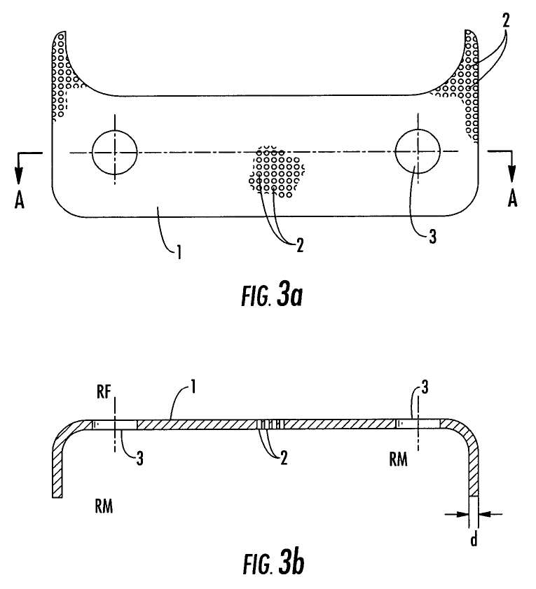

FIGS. 3a and 3b show each a panel 1 made of polyamide, that is three-dimensionally shaped and presents a network of perforations 2 configured as holes which, for the sake of simplicity, are illustrated only at a central position and at two upper terminal positions in FIG. 3a even though they cover the entire surface of the panel 1 in the form of a regular network and are disposed in lines. Moreover, the panel 1 presents recesses or major perforations 3 serving to pass apparatuses of the motor vehicle therethrough. The perforations 2 present a circular cross-section in particular; they pass through the entire panel 1 to the other side, particularly up to the passenger compartment RF. The length of the perforations 2 and therefore also the thickness d of the panel 1 amounts to roughly 3 mm in this example, at a hole diameter of 0.12 mm.

In correspondence with FIG. 4 the panel 1 made of polypropylene comprises a hole as perforation 2 at a specified position, that has a substantially circular cross-section. The hole has a diameter D of 0.5 mm, for instance. The length L of the hole, that corresponds to the thickness d of the panel 1, amounts to 3 mm in this example. Here a hole surface LF of 0.20 mm² derives from the formula

$$\frac{LF = π \cdot {D}^{2}}{4}$$

and a hole volume V of 0.6 mm³ is obtained from the formula
V=LF·D.

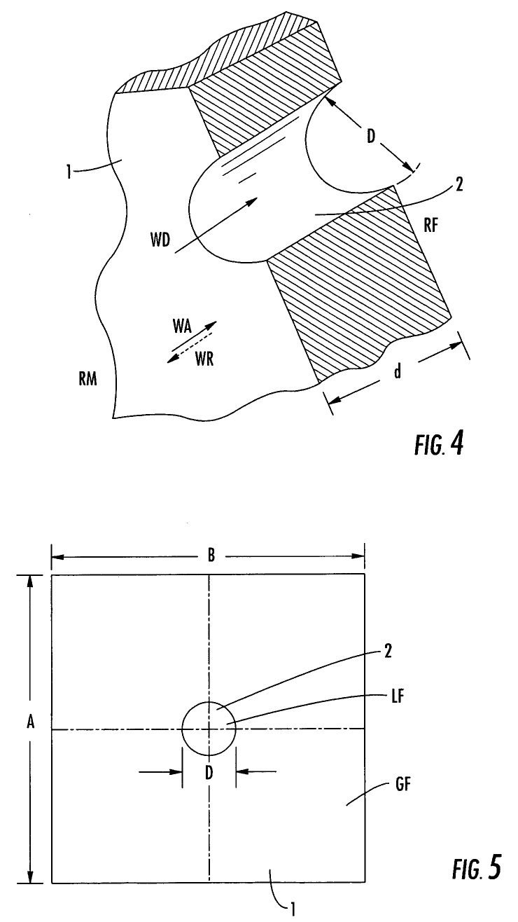

The majority of the sound waves WA incident on the perforated panel 1 is reflected as reflection waves WR at the surface of the perforated panel 1 whilst another fraction, i.e. the waves WD passing therethrough, enters the perforation 2 and initiates physical effects in the gas volume contained there, which lead to an absorption of the total of the incident waves that is much higher than this would correspond to the hole/surface ratio LV. The hole/surface ratio LV is the ratio of the hole surface LF covered by perforations 2 to the total surface GF covered by both the perforations 2 and the remaining surface of the perforated panel 1, in correspondence with the following formula
LV=LF/GF
in accordance with the relationships schematically illustrated in FIG. 5.

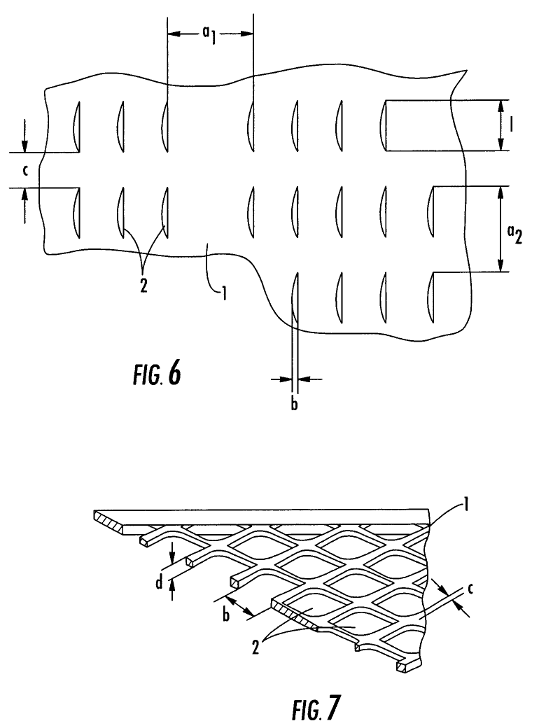

The sound shielding element configured as mounting part according to FIG. 6 consists of a panel 1 made of aluminium and having a thickness of layer d=0.5 mm. The panel 1 is provided with a multitude of slot-like perforations 2 having a slot length 1 of 1.6 mm, in particular, and a slot width b (at the broadest location) of 0.09 to 0.1 mm. The spacing a1 between perforations 2 disposed side by side amounts to roughly 1 mm (calculated from the mutually corresponding sides of the slots) ands the spacing a2 between mutually corresponding ends of adjacent slots amounts to roughly 2.5 mm so that an effective spacing c of 0.9 mm is obtained in correspondence with the formula
c=a2−1.

FIG. 7 illustrates another embodiment of the invention that corresponds more closely to the expanded metals so far used for other applications. The panel 1, that has a thickness of layer d=0.5 mm, is slotted here first by means of cutter blocks or blade carrying rails. In or subsequent to this operation the layer 1 is so stretched that the narrow slots are spread to form approximately lozenge-shaped perforations 2, with the initially planar surface of the panel 1 being simultaneously distorted without cutting. The slot width b in the finished mounting part according to FIG. 7 amounts to roughly 1 to 2 mm at a very small web width c of roughly 0.03 mm, which corresponds to the distance between adjacent perforations 2.

Whereas the hole/surface ratio in the embodiment of FIG. 6 ranges between 5 and 6% approximately, this ratio is substantially higher, even though smaller than 20%, in the other embodiment according to FIG. 7 in the region of the perforations 2.

In the embodiment of FIG. 6, the number of slots is 1,000/metre over the length of the mounting part and 400/metre over the width or height of the mounting part, i.e. parallel to the longitudinal extension LE of the slot-shaped perforations 2. In another version resembling that of FIG. 6 the following dimensions are chosen:
a₁=1.4 mm
a₂=2 mm
b=0.2 mm
1=0.9 mm.

The inventive mounting part is suitable for application, for instance, also in housings of household appliances such as vacuum cleaners and hair driers. In such a case, however, the application of injection moulding or deep-drawing techniques is recommended for the production of the moulded part.

Due to their bending stability and their low weight so-called “honey-comb” composite panels, i.e. honey-comb-like structural parts, may be preferably covered on both sides with an inventive sound shielding element so as to obtain a double-sided “micro-porous absorber”.

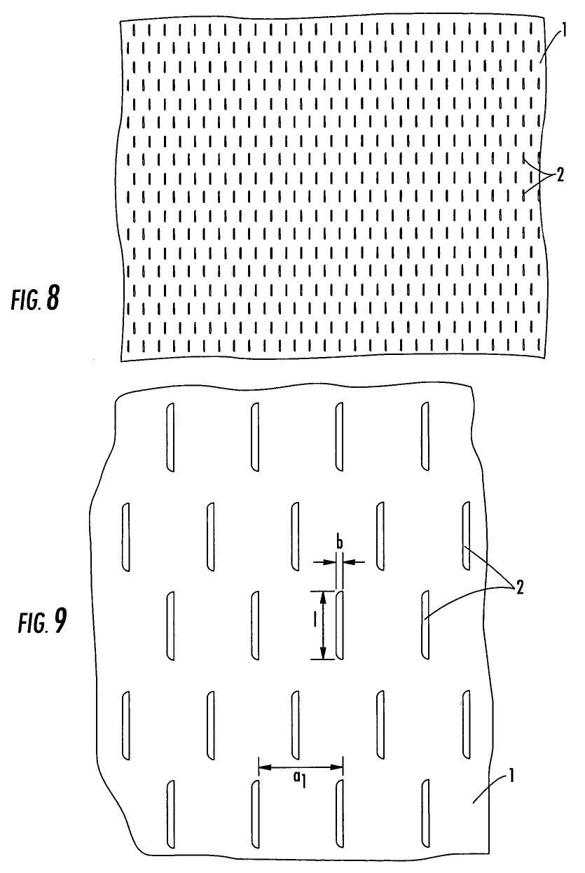

FIG. 8 shows the enlarged plan view of one part of an embodiment of the invention wherein elongate slot-like perforations 2 are shown in adjacent rows, each with an offset. FIG. 9 shows the same embodiment as FIG. 8 in an even further enlarged illustration, wherein the slot arrangement of the elongate perforations 2 shown here may be seen with roughly 100 to 150 μm in width b and with a length 1 of roughly 2 mm when looking through against the light. In a plan view, the perforations 2 such as those shown in FIG. 8 are hardly visible as perforations letting light pass, rather the impression of a structure having elongate projections and recesses is obtained. The distance a₁, that amounts to 1.21 approximately, is longer than the slot length 1.

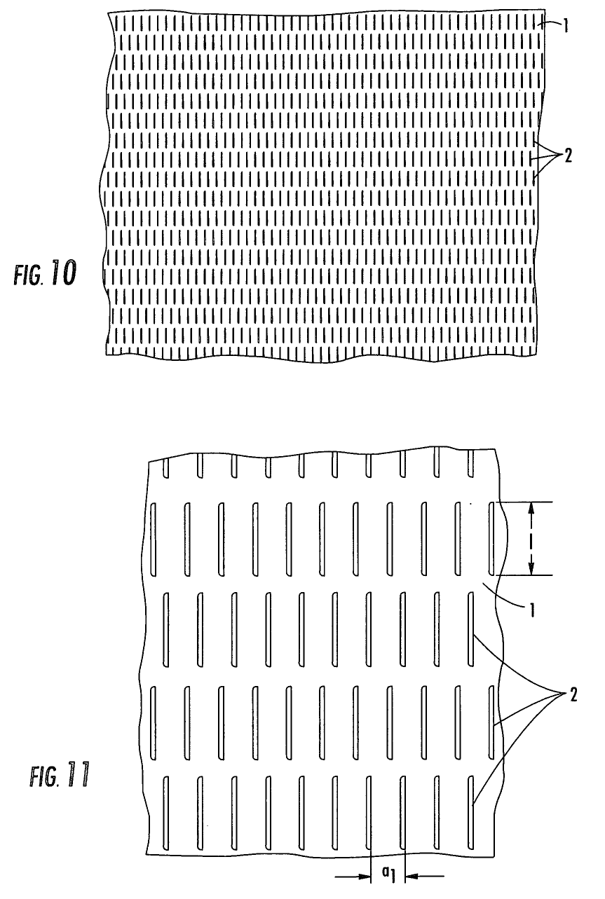

FIGS. 10 and 11 illustrate another embodiment of the invention in a respective plan view and phantom view, with the distinction that the perforations 2 are adjacent to each other much more closely, with spacings a₁ of less than half the slot length 1 of the perforations 2; in this example of roughly 0.45 1. With this provision a wider-band sound absorption is surprisingly achieved, compared against the embodiment of FIGS. 8/9.

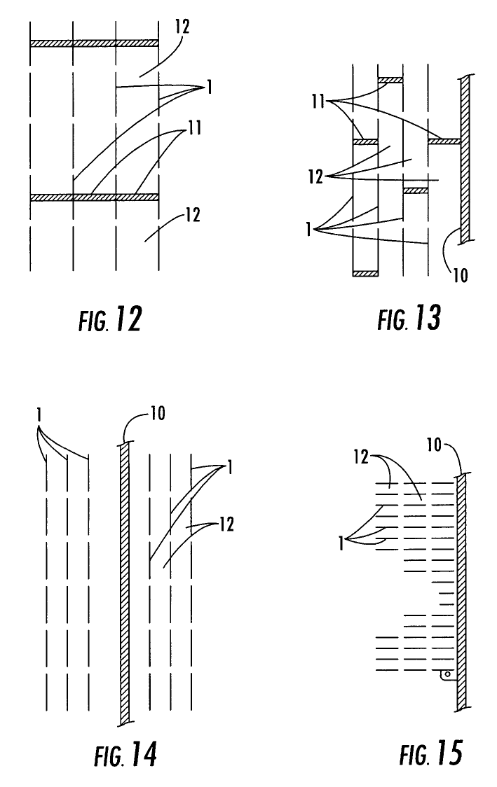

In accordance with FIG. 12 several panels 1 or layers are connected to a multi-layer absorber element. There several individual layers or panels 1 may result in an even higher distinct increase of the wide-band characteristic with the appropriate selection and an appropriately different dimensioning of the perforations in the panels, different from that in a single layer. With this provision the absorption can be further improved mainly in the range of deep frequencies. Spacers 11 hold the individual layers in a mutually spaced position, with air layers or spaces 12 being formed therebetween.

FIG. 13 illustrates a schematic cross-sectional view of the assembly of a multi-layer absorber element consisting of four separate layers or individual panels 1 from a wall 10. Here, too, spacers 11 are used.

According to FIG. 14, a corresponding multi-layer absorber is mounted on both sides of a noise protection wall 10. The spacers may also be configured as so-called “cassettes”, i.e. in the form of box-like objects defined by walls on four sides and open on the two face sides.

In accordance with FIG. 15, the individual panels 1 are disposed in front of the wall 10, specifically orthogonally on the latter, in a way that they join the wall directly and are spaced from each other and extend at a right angle relative to the wall 10. The structure of the component may be configured in the manner of a “shelf system” and also in the manner of a “honey-comb” system presenting a rectangular honey-comb structure in particular.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. Sound-shielding element for covering at least one of sound-reflecting or sound-generating structural parts, comprising:
at least one panel or layer;
a plurality of small perforations formed in said at least one panel or layer;
wherein an average diameter or width of said perforations ranges between 0.001 and 0.7 mm and a hole/surface ratio ranges between 0.001 and 8% so that the sound waves entering said perforations initiate physical effects in a gas volume contained in said perforations.

2. Sound-shielding element according to claim 1, wherein said panel presents a thickness between 0.05 and 4 mm, an average diameter or width of said perforations between 0.01 and 0.7 mm and a hole/surface ratio between 0.01 and 5%.

3. Sound shielding element according to claim 1, wherein said panel or layer is made of polypropylene.

4. Sound shielding element according to claim 1, wherein said perforations are configured as narrow or fine slots having width between 0.02 and 0.18 mm and a length between 0.02 and 30 mm.

5. Sound shielding element according to claim 4, wherein said slots have width between 0.08 and 0.15 mm and slot length between 0.8 and 2.2 mm and are disposed at an offset at a spacing transversely to a longitudinal extension by less than half the slot length.

6. Sound shielding element according to claim 1, wherein said panel is configured as a three-dimensionally shaped moulded part and is injection-moulded or pressed from synthetic material.

7. Sound shielding element according to claim 1, wherein said panel or layer is three-dimensionally shaped without cutting by stretching.

8. Sound shielding element according to claim 1, wherein said panel or layer is deep-drawn from a planar plate, board, tape, strip or sheet.

9. Sound shielding element according to claim 2, wherein said panel presents a thickness between 0.2 and 1 mm.

10. Sound shielding element according to claim 9, wherein said panel or layer is provided with said perforations in a sieve-like or raster-like form.

11. Sound shielding element according to claim 1, wherein said panel or layer comprises aluminium, steel sheet, ceramic or a highly temperature-resistant synthetic material.

12. Sound shielding element according to claim 1, wherein said panel or layer is used as a covering layer on a sound-absorbing layer including a nonwoven fabric or foamed material or on a chamber-type or membrane-type absorber, and presents the hole/surface ratio between 3 and ˜10% and an average hole diameter between 0.1 and 0.5 mm.

13. Sound shielding element according to claim 1, wherein said element is used as an injection-moulded operating element.

14. Sound shielding element according to claim 1, wherein said element is used as roof lining in a passenger compartment of motor vehicles.

15. Sound shielding element according to claim 1, wherein said element is used on an underbody lining of motor vehicles.

16. Sound shielding element according to claim 1, wherein said element is used as an injection-moulded cover unit for covering cables.

17. Sound shielding element according to claim 1, wherein said element is a wheel case shell on motor vehicles.

18. Sound shielding element according to claim 1, wherein said element is a hat rack in motor vehicles.

19. Sound shielding element according to claim 1, wherein said element is a seat cover in motor vehicles.

20. Sound shielding element according to claim 1, wherein said element is a door lining.

21. Sound shielding element according to claim 1, wherein said element is an absorbing tube for air-conducting tubes.

22. Sound shielding element according to claim 1, wherein said element is a decorative wheel shield or engine bonnet lining of motor vehicles.

23. Sound shielding element according to claim 1, wherein said element is a cover for covering at least one part of an internal combustion engine.

24. Sound shielding element according to claim 1, wherein said element is a luggage trunk cover.

25. Sound shielding element according to claim 1, wherein said element is a thermal shielding element.

26. Sound shielding element according to claim 1, wherein said element is a covering layer on honey-comb composite panels.

27. Sound shielding element according to claim 1, wherein at least two said panels are spaced from each other and disposed in a substantially parallel arrangement.

28. Method of producing a sound-shielding element for covering at least one of sound-reflecting or sound-generating structural parts, the element including at least one panel or layer, a plurality of small perforations formed in said at least one panel or layer, wherein an average diameter or width of said perforations ranges between 0.001 and 0.7 mm and a hole/surface ratio ranges between 0.001 and 8% so that the sound waves entering said perforations initiate physical effects in a gas volume contained in said perforations, the method comprising: forming said panel or layer by fusing or bonding particles or fibers.

29. Method of producing a sound shielding element according to claim 28, wherein said panel or layer is produced by weaving threads formed of fibers.

30. Method of producing a sound shielding element according to claim 28, wherein said panel is produced by impregnating a textile tissue with a thermoplastic material and molding into a three-dimensional shape.

31. Method of producing a sound shielding element according to claim 28, wherein said plurality of perforations are produced by electric discharges using an electric arc through said panel or layer.

32. Method of producing a sound shielding element according to claim 28, wherein said plurality of perforations are produced by bombardment of said panel or layer with particles.

33. Method of producing a sound shielding element according to claim 28, wherein said plurality of perforations are produced by means of a needle or cutter blocks.

34. Method according to claim 33, wherein distortions of said perforation in said panel or layer are closed by pressing by shaping rollers.

35. Sound-shielding element, comprising:
at least one panel or layer for covering at least one of sound-reflecting or sound-generating structural parts;
a plurality of small perforations formed in said at least one panel or layer;
wherein an average diameter or width of said perforations ranges between 0.001 and 0.7 mm and a hole/surface ratio ranges between 0.001 and 8% so that the sound waves entering said perforations initiate physical effects in a gas volume contained in said perforations.
